(19) United States
(12) Patent Application Publication
(10) Pub. No.: US 2012/0297934 A1
(43) Pub. Date: Nov. 29, 2012

(54) SOCKET WITH RATCHET MECHANISM

(75) Inventor: John M. Peirce, Portage, MI (US)

(73) Assignee: AMERICAN GREASE STICK COMPANY, Muskegon Heights, MI (US)

(21) Appl. No.: 13/195,978

(22) Filed: Aug. 2, 2011

(30) Foreign Application Priority Data
May 26, 2011 (GB) 1108832.5

(51) Int. Cl. B25B 13/46; B25B 13/06

(52) U.S. Cl. 81/60; 81/124.6

(57) ABSTRACT

A socket and ratchet combination includes a socket element and a ratchet device or module. The ratchet device is a self-contained ratchet device module having a housing that houses a ratchet mechanism, and the socket element includes a passageway that is configured to receive the housing of the ratchet device therein. When a drive member of a lever arm is connected to the ratchet device and the lever arm is rotated in a first direction, the ratchet device and the socket element rotate in the first direction to rotatably drive a fastener at least partially received at an end region of the socket element, and when the drive member of the lever arm is connected to the ratchet device and the lever arm is rotated in a second direction, the ratchet device allows the lever arm to rotate in the second direction relative to the socket element.

### CROSS REFERENCE TO RELATED APPLICATION

The present application claims priority benefit of GB patent Application No, GB1108832.5, filed May 26, 2011, which is hereby incorporated herein by reference in its entirety.

### FIELD OF THE INVENTION

The invention relates to ratchet mechanisms and wrenches and sockets.

### BACKGROUND TO THE INVENTION

Known socket wrenches comprise a socket element having a non-circular passageway or receiver for engaging a fastener head, with the socket element being removably attached to a ratchet head that houses a ratchet mechanism therein. The ratchet mechanism is integral to the ratchet head and the socket element comprises no moving parts. The socket element typically comprises a fastener receiving portion having a generally hexagonal-shaped passageway (or a twelve point passageway or the like) and a separate attachment portion having a square-shaped opening for receiving a drive member of the ratchet head. Such socket configurations thus have different passageways or receptacles that are formed separately via separate machining operations, adding complexity and cost to the socket element.

### SUMMARY OF THE INVENTION

The present invention provides a ratchet and socket combination or device that is attachable to a drive member, such as a wrench handle or the like, and that incorporates a ratchet mechanism in the socket element. The ratchet mechanism or ratchet device or module may comprise a one-way ratcheting mechanism and may be removable from an end of the socket and flipped over to reverse the drive direction of the socket, or the ratchet mechanism may be generally fixedly attached in the socket and the socket may have a fastener receiving portion at opposite ends thereof, whereby the drive direction of the socket may be reversed by reversing or flipping over the socket element.

The ratchet device or module may be received in a passageway of a socket element, with the housing of the ratchet device or module having an outer surface that generally corresponds to the inner surface of the socket passageway. A driving member of the ratchet device or module (that rotatably drives the ratchet module housing) may have a connection aperture or hole or protrusion or other keyed connection or connecting means for connecting or attaching a lever arm or breaker bar or T-bar or the like, whereby rotational driving of the lever arm in a driving direction rotatably drives the driving member and housing and socket element in that direction, while the ratchet mechanism allows for rotation of the lever arm and driving member in the opposite or non-driving direction relative to the ratchet module housing and the socket element.

The present invention also provides a socket and ratchet combination comprising a socket element and a self-contained ratchet module, with the socket element having a passageway and an axis of rotation coaxial with the passageway. The ratchet module has a peripheral surface received in and engaging the passageway and an input drive receiving formation disposed on the axis of rotation and configured to connect with an input drive device to receive a rotational input drive therefrom. When the input drive is applied to the input drive receiving formation in a first direction of rotation, the input drive is transmitted to the socket element by the engagement between the peripheral surface and the passageway, and when the input drive is applied to the input drive receiving formation in a second direction of rotation, the ratchet module permits rotation of the drive receiving formation relative to the socket element.

The present invention also provides a socket and ratchet system comprising a first socket element, a second socket element and a ratchet module, with each of the socket elements having a different diameter passageway for receiving a different diameter fastener element therein. The ratchet module has an outer structure configured to engage an inner wall of the first socket element, with the second socket element having a passageway having a larger diameter than the outer structure. The ratchet module comprises a self-contained ratchet device or module having a housing that houses a ratchet mechanism and having an input drive connecting structure at an axis of rotation of the ratchet module. The ratchet module is configured to connect to a drive member of a lever arm at the input drive connecting structure, and when the drive member of the lever arm is connected to the ratchet module and the lever arm is rotated in a first direction, the ratchet mechanism and a respective socket element rotate in the first direction to rotatably drive a fastener at least partially received at an end region of the respective socket element, and when the drive member of the lever arm is connected to the ratchet module and the lever arm is rotated in a second direction, the ratchet mechanism allows the lever arm to rotate in the second direction relative to the respective socket element. The system further comprises an adapter that can be selectively disposed at least partially around the outer structure of the ratchet module to adapt the diameter of the outer structure of the ratchet module for use in the second socket element, which has a larger diameter passageway than the first socket element.

The present invention also includes a socket and ratchet combination comprising a socket element and a self-contained ratchet module, with the socket element having a passageway and an axis of rotation coaxial with the passageway. The ratchet module has a peripheral surface received in and engaging the passageway and an input torque receiving formation disposed on the axis of rotation and configured to connect with an input drive device (such as a lever arm or T-bar or the like) to receive an input torque therefrom. When the input torque is applied to the input torque receiving formation in a first direction of rotation, the input torque is transmitted to the socket element by the engagement between the peripheral surface and the passageway, and when the input torque is applied to the input torque receiving formation in a second direction of rotation, the ratchet module permits rotation of the drive receiving formation relative to the socket element,

The present invention also provides a ratchet mechanism (that is suitable for a stand-alone ratchet module or as part of a ratchet wrench or socket driver or the like) that includes an outer member and an inner member. The outer member has a generally cylindrical inner surface and a plurality of teeth disposed circumferentially around the inner surface, and the inner member is disposed at least partially within the outer member, with the inner member comprising at least one pawl disposed at an outer circumferential surface thereof. The pawl is configured to engage the teeth of the outer member to limit rotation of the inner member relative to the outer member when one of the inner member and the outer member is rotatably driven in a driving direction. The pawl comprises a base portion and a tab portion, with the base portion of each pawl pivotally received in a respective partially circular recess established in the inner member and with the tab portion extending from the base portion for engaging the teeth of the outer member. The tab portion is disposed generally along the outer circumferential surface of the inner member when in a retracted state and the tab portion extends generally away from the outer circumferential surface when in an engaging state for engaging the teeth of the outer member.

Optionally, the at least one pawl may comprise a plurality of pawls spaced around the circumference of the inner member. The tab portions of the pawls may be urged away from the sidewall of the inner member by a respective biasing element disposed at the inner member.

In one form, the inner member may comprise a driving member that is rotatably driven via a driving handle, whereby the outer member is rotatably driven in the driving direction via engagement of the tab portions of the pawls with the teeth of the outer member when the inner or driving member is rotated in the driving direction, Such a configuration may be suitable for use as a ratchet unit or module that is disposed at or at least partially in a socket element, with a handle engaging the inner member via a projection or drive element of the handle being received in a corresponding aperture of the inner member. In another form, the outer member may comprise a driving member that is rotatably driven via a driving handle, whereby the inner member is rotatably driven in the driving direction via engagement of the tab portions of the pawls with the teeth of the outer member when the outer or driving member is rotated in the driving direction. Such a configuration may be suitable for use as part of a ratchet handle, with the inner member including a projection or drive element that is received in a corresponding aperture of a socket element.

These and other objects, advantages, purposes, and features of the present invention will become apparent upon review of the following specification in conjunction with the drawings.

### BRIEF DESCRIPTION OF THE DRAWINGS

In order that the invention may be well understood, some examples thereof, which are given by way of example only, will now be described with reference to the drawings in which:

FIG. 1 is an exploded perspective view of a socket and ratchet combination in accordance with the present invention with the ratchet device removed from the socket element;

FIG. 2 is a perspective view of the socket and ratchet combination of FIG. 1, shown with the ratchet device or module retained at an end region of the socket element;

FIG. 3 is a sectional view of the socket and ratchet combination of FIG. 2;

FIG. 4 is a plan view of the socket element of the socket and ratchet combination of FIG. 2, shown with the ratchet device removed;

FIG. 5 is a plan view of a ratchet device suitable for use with the socket and ratchet combination of FIG. 2;

FIG. 6 is a perspective view of the socket element of FIG. 5;

FIGS. 7-10 are adapters suitable for use with the socket and ratchet combination of FIG. 2, in order to allow a single ratchet device or module to be used in combination with different sizes of socket elements;

FIG. 11 is an exploded perspective view of a socket and ratchet combination in accordance with the present invention with the ratchet device or module removed from the socket element;

FIG. 12 is a perspective view of the socket and ratchet combination of FIG. 11, shown with the ratchet device or module retained in the socket element;

FIG. 13 is an end view of the socket and ratchet combination of FIG. 11;

FIG. 14 is a sectional view of the socket and ratchet combination of FIG. 11;

FIG. 15 is a plan view and partial sectional view of a ratchet device or module of the present invention, showing parts of the ratchet mechanisms of the ratchet device or module;

FIG. 16 is a plan view of a stacked pawl configuration of the ratchet device or module of FIG. 15; and

FIG. 17 is a perspective view of the stacked pawl configuration of FIG. 16.

### DETAILED DESCRIPTION OF THE PREFERRED EMBODIMENTS

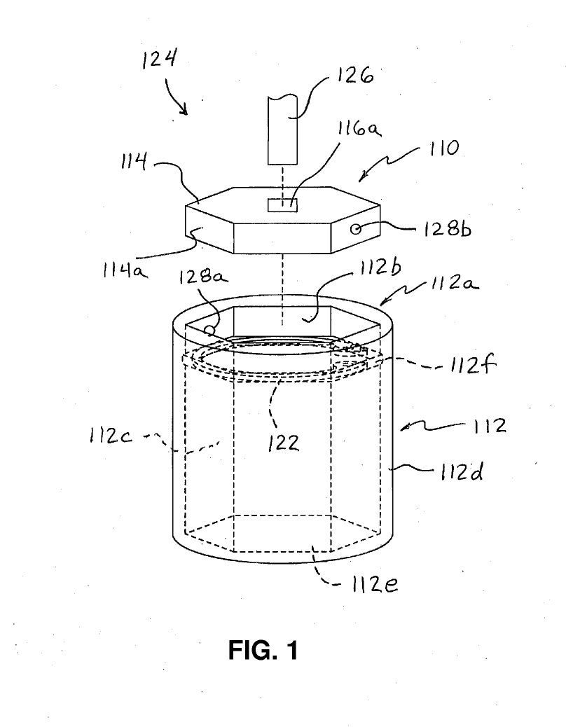

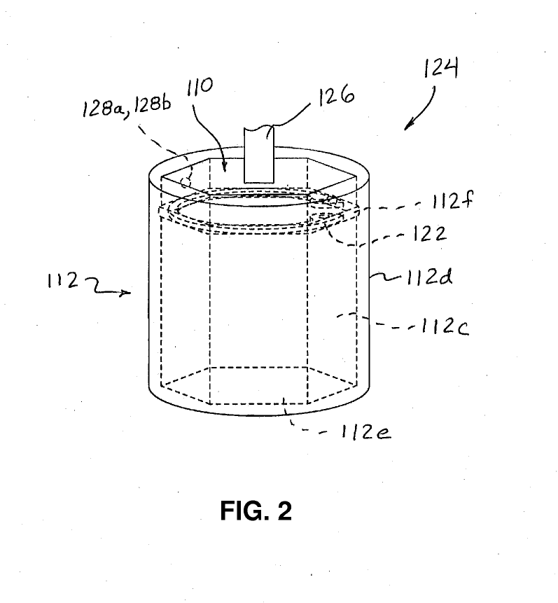

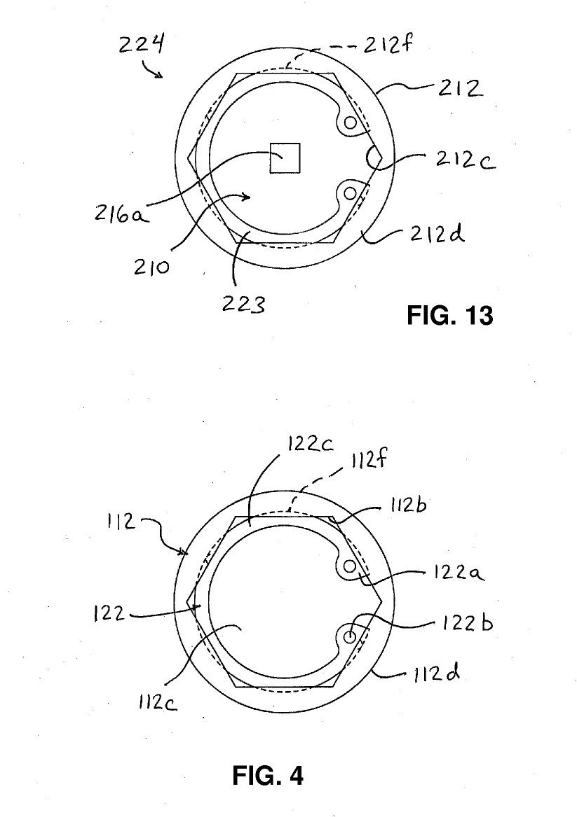

Referring now to the drawings and the illustrative embodiments depicted therein, a ratchet device or module or unit 110 comprises a self-contained ratchet mechanism that is configured to be non-rotatably received in a targeted article, such as a socket element 112 or the like (FIGS. 1-6), Ratchet device 110 includes an outer housing or shell or driven member 114 that has a non-circular perimeter shape to correspond to the non-circular shape of a passageway or receiver of a socket element 112 or the like, as discussed below.

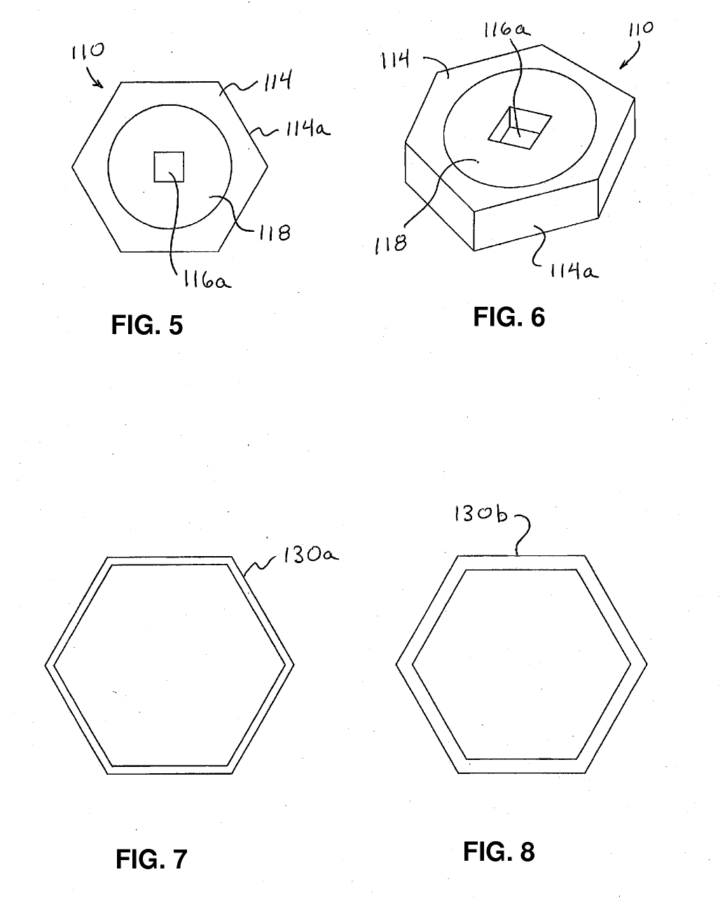

Housing 114 of ratchet device 110 houses the ratcheting mechanism therein, and the ratcheting mechanism may comprise any suitable ratcheting means. For example, the ratcheting mechanism may comprise a one-way ratcheting mechanism that rotatably drives the socket in one direction and ratchets when rotated in the other direction to allow for relative rotation between the lever arm and the socket element, such as via any known ratchet mechanisms or the like. Optionally, the ratcheting mechanism may comprise a two-way ratcheting mechanism that selectively (such as responsive to a user selecting a direction via movement of a toggle or switch or button or the like at the ratchet module) rotatably drives the socket in a selected direction and ratchets when rotated in the other direction to allow for relative rotation between the lever arm and the socket element. The housing 114 of ratchet device 110 comprises, for example, a generally hexagonal-shaped outer surface 114a with a generally cylindrical through-hole or passage 114b that defines a generally cylindrical chamber in which a driving member 116 is housed. A cover or sealing element 118 (FIGS. 5 and 6) may be secured at each of the opposite ends of the housing 114 to substantially seal the driving member 116 and ratcheting elements therein.

The driving member 116 is a generally non-cylindrical body provided with an axially extending through-hole 116a which is configured to receive a standard square drive extension of a lever arm or breaker bar or the like (such as a ¼ inch drive extension or a ⅜ inch drive extension or a ½ inch drive extension or the like).

Referring now to FIGS. 1-3, ratchet device 110 may be inserted into or received in or at an end region 112a of a socket element 112, such that the outer surface 114a of housing or driven member 114 engages with and abuts against an inner surface 112b of a non-circular passageway 112c (such as a hexagonal-shaped passageway or the like) extending through socket element 112. The ratchet device 110 is sized to fit in an appropriate or selected size socket, such that each socket and socket size may have an associated ratchet device or optionally, one or more adapters or sleeves or spacers may be utilized to adapt the ratchet device to work with multiple sized socket elements, such as discussed below. A locking ring or stop element 122 is received and retained in passageway 112c to provide a stop surface against which a perimeter surface of the inward face of ratchet device 110 may rest when the ratchet device is inserted into or received in end region 112a of socket element 112.

For example, and with reference to FIGS. 1-3, a ratchet and socket assembly 124 comprises socket element 112 and ratchet element or device or module or mechanism 110, which is removably disposed at an end region 112a of socket element 112. Ratchet device 110 may comprise any suitable ratchet mechanism and may comprise a one way ratcheting mechanism. As shown in FIGS. 1-3, ratchet device 110 is received in end region 112a of socket element 112, and includes aperture 116a for receiving a drive shaft or attachment element 126 of a lever arm or handle, such as part of a breaker bar or T-bar or handle or the like. The ratchet device 110 thus may be inserted into or received in or retained in or at the end region 112a of socket element 112, and a lever arm or handle may be readily connected to the ratchet device to rotatably drive the socket element to tighten or loosen a fastener.

In the illustrated embodiment, socket element 112 comprises a unitary body portion 112d with a non-circular passageway 112c (such as a hexagonal-shaped passageway) formed entirely therethrough (with the hexagonal-shaped passageway being uniform and continuous entirely along and through the socket element). Such a configuration can be readily manufactured without the complexities involved in the manufacture of conventional sockets, which typically have a hexagonal-shaped passageway extending partially along the socket and a smaller square-shaped receiver at an end thereof for receiving a drive shaft of a ratcheting lever arm. The passageway 112c of socket 112 includes a fastener receiving end or region 112e (configured to non-rotatably receive a fastener or fastener head therein) that is generally at an opposite end of the body portion 112d from the ratchet device receiving end region 112a. The socket element 112 may also include a ring receiving groove or channel 112f established near the end region 112a for receiving the locking ring or retainer 122 therein,

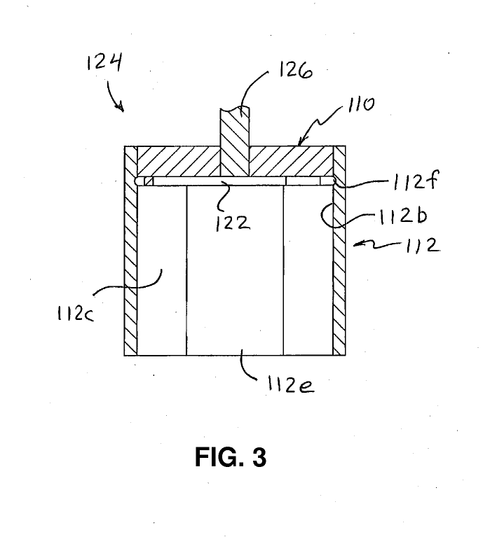

The locking ring or snap ring 122 may be inserted into passageway 112c when in a compressed state and may be released to an expanded state at the groove or channel 112f, whereby the locking ring 122 is retained partially in groove or channel 112f to provide a stop surface against which ratchet device 110 may engage when the ratchet device 110 is inserted into socket element 112 at end region 112a, In the illustrated embodiment (and as best shown in FIG. 3), the locking ring 122 comprises a generally circular-shaped split ring with tabs 122a at its opposed terminal ends, The tabs 122a facilitate compression of the ring (such as via a tool with prongs that are received in apertures 122b at the tabs 122a) so that the ring may be compressed to a size that may slide in and along the passageway 112c and then may be released to allow expansion of the ring (due to the biasing of the ring towards its initial uncompressed state) so as to at least partially be received in the groove or channel 112f of the socket element. The ring then provides a perimeter surface 122c at the perimeter of the passageway against which the ratchet device 110 may engage or rest when the ratchet device is inserted into or received in the end region 112a of socket 112.

Thus, when inserted or plugged into the socket element in one orientation or direction, the ratchet device may rotatably drive the socket and fastener in one direction via rotation of the lever arm in that direction, while providing a ratcheting function when the lever arm is rotated in the other direction. The socket element thus would include and house its own ratcheting mechanism and could be driven via any lever arm or bar or the like. The ratchet and socket assembly may be attached to either a breaker bar or T-handle or the like with the appropriate length extension (such as anywhere from about 1 inch to about 48 inches depending on the application) and would have much of the stress directly over the fastener rather than at the end of a long handle such as a standard ratchet handle. When it is desired to rotate or drive the fastener in the opposite direction, the ratchet device may be removed from the socket element and flipped over 180 degrees and then reinserted into the socket element, whereby the ratchet device may rotatably drive the socket and fastener in the opposite direction when the lever arm is rotated in that direction.

Optionally, the ratchet device 110 and/or the socket element 112 may comprise retaining means for retaining ratchet device 110 in passageway 112c at end region 112a of socket element 112 when ratchet device 110 is inserted into the passageway and engaged against locking ring 122. For example, the retaining means may comprise a detent 128a established at the inner surface of the socket body 112d and a ball 128b disposed at housing 114 of ratchet device 110 and biased outwardly (such as via a spring or the like) so that the ball is urged into the detent 128a when the ratchet device 110 is received in the socket element 112, yet may be pressed into or partially into the housing 114 to allow for removal of the ratchet device when the ratchet device is urged or pulled or pushed from the socket element.

Optionally, the retaining means may comprise any other suitable means for retaining or detachably retaining the ratchet device in the socket, such as, for example, magnets or magnetic elements disposed at the housing 114 of the ratchet device 110 and/or at the body 112d of the socket element 112 to magnetically retain the ratchet device at the socket element and to limit accidental dislodgement of the ratchet device from the socket element (and optionally, the material of the housing 114 and/or the socket body 112d and/or the ring 122 may be magnetic or magnetized to enhance retention of the ratchet device in the socket element). Preferably, the retaining means substantially retains the ratchet device in the socket element, but allows for a user to readily remove the ratchet device from the socket element when desired, such as to use the ratchet device in another socket or such as to rotate the socket and fastener in the opposite direction.

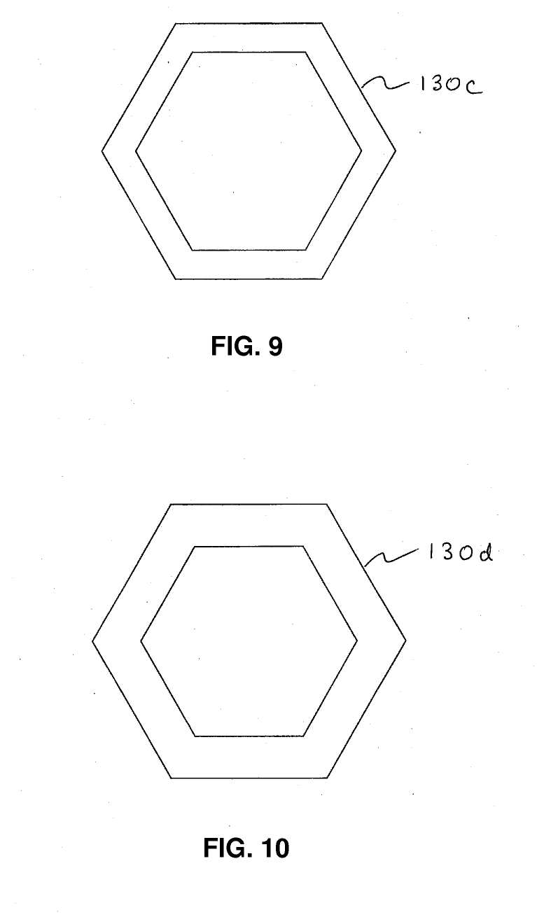

Thus, the ratchet and socket assembly provides a socket element with the ratchet mechanism forming a part thereof. The ratchet device or module or unit can be removed from the socket element and flipped over to reverse the drive direction of the ratchet and socket assembly. Optionally, the ratchet device may be useable in connection with different sized socket elements, such as sockets having different diameter passageways or through-holes. In such an application, a spacer of appropriate thickness may be disposed between the outer surface 114a of the ratchet device 110 and the inner surface 112b of the socket element 112 to provide a tight fit or engagement between the ratchet device and the socket element. For example, and with reference to FIGS. 7-10, one of several spacer elements or adapters or sleeves 130a, 130b, 130c, 130d may be disposed between the outer surface 114a of the ratchet device 110 and the inner surface of a respective socket element. For example, ratchet device 110 may be sized for insertion into a 15 mm diameter hexagonal socket, and may be used in a 16 mm diameter socket with a 1 mm thick spacer element or sleeve 130a, or may be used in a 17 mm diameter socket with a 2 mm thick spacer element or sleeve 130b, or may be used in a 18 mm diameter socket with a 3 mm thick spacer element or sleeve 130c, or may be used in a 19 mm diameter socket with a 4 mm thick spacer element or sleeve 130d.

Thus, a spacer element or sleeve of an appropriate size may be slid over the ratchet device to size the ratchet device to fit a selected socket, and thus, multiple socket elements may be adapted to receive a respective self-contained ratchet device or module or unit. For example, a socket set of fifteen socket elements (such as a set starting with a 6 mm socket diameter and going up to a 20 mm socket diameter) may only need three ratchet units and a plurality of spacers or sleeves (such as four spacers with an internal diameter that matches the exterior diameter of one of the ratchet units, and four spacers with an internal diameter that matches the exterior diameter of another of the ratchet units, and four spacers with an internal diameter that matches the exterior diameter of the third one of the ratchet units). Optionally, the spacer elements or sleeves may be colour coded or otherwise coded or marked or identified and the sockets may also be colour coded or otherwise coded or marked or identified to ease the user's ability to readily match the right sleeve size to the selected socket for a given ratchet module.

The spacer element may be retained to the ratchet device and/or socket via any suitable retaining means, such as a ball and detent retaining means or magnetic elements (such as a magnetic or magnetized locking ring or socket or sleeve or ratchet housing or the like). It is envisioned that the spacer or sleeve element, at least for the larger or thicker spacers or sleeves, may include a groove for receiving a stop ring or the like to limit travel of the ratchet module through the spacer, such as for applications where the through hole of the spacer is inboard of the stop ring of the socket element such that no portion of the stop ring blocks or limits the movement or insertion of the ratchet module into and through the spacer passageway. Optionally, the stop ring at the socket element may be sized so as to substantially encroach on the socket passageway so that at least a portion of the stop ring blocks the passageway of the largest spacer or sleeve element when the spacer or sleeve element is inserted into the socket passageway and rests at the stop ring. Optionally, the spacers or sleeve elements may include an integral tab or flange at an end thereof that extends partially across or into the passageway or through hole so as to limit movement of the ratchet module through the spacer or sleeve element. Other means for limiting movement of the ratchet module within the spacer or sleeve element (particularly for larger sized spacers or sleeves where the thickness of the spacer or sleeve is greater than the thickness of the stop surface of the stop ring in the socket element) may be implemented or incorporated in the spacer or sleeve while remaining within the spirit and scope of the present invention. Optionally, the end region of the sockets at which the ratchet device is received may be sized differently than the fastener receiving portion, so that no sleeves are required to use the same ratchet device on different sized sockets, but such a configuration would result in an increased cost socket, due to the different diameter passageway or through-hole that extends along and through the socket element.

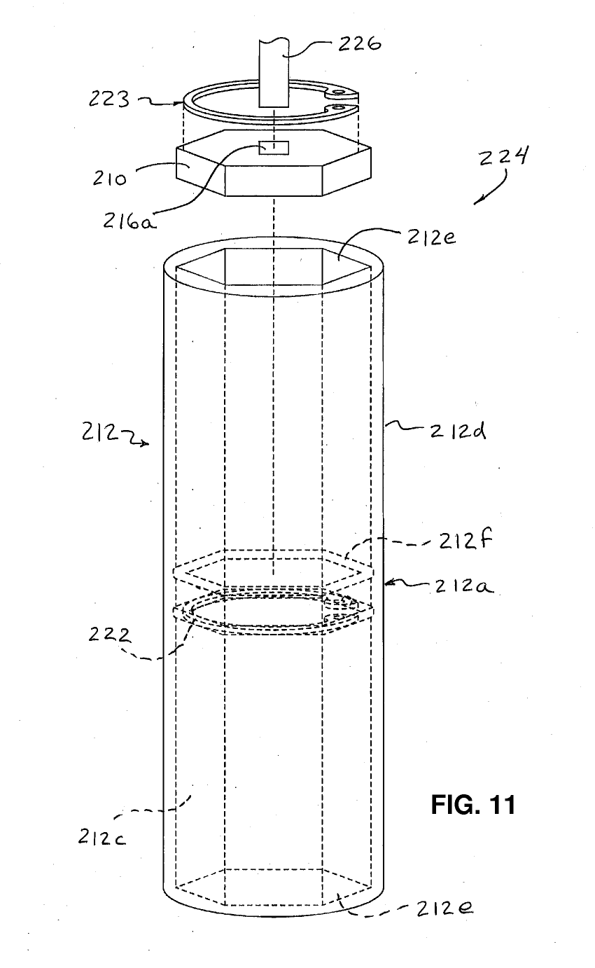

Optionally, it is envisioned that the ratchet device or module or unit may be substantially fixedly retained in the socket element to provide a ratchet and socket assembly for use with a lever arm or the like. For example, and with reference to FIGS. 11-14, a ratchet and socket assembly or combination 224 comprises an elongated socket element 212 and a ratchet element or device or module or mechanism 210 that is disposed at and retained at a generally central region 212a of socket element 212. Ratchet device 210 may comprise any suitable ratchet mechanism and may comprise a one way ratcheting mechanism (such as similar to ratchet device 110). Ratchet device 210 is received in generally central region 212a of socket element 212, and includes an aperture 216a for receiving a drive shaft or attachment element 226 of a lever akin or handle. The ratchet device 210 thus may be inserted into or received in the generally central region 212a of socket element 212 and is retained in or at the generally central region 212a of socket element 212 via a pair of snap rings or lock rings 222, 223, and a lever arm or handle may be readily connected to the ratchet device to rotatably drive the socket element to tighten or loosen a fastener.

In the illustrated embodiment, socket element 212 comprises a unitary body portion 212d with a non-circular passageway 212c (such as a hexagonal-shaped passageway) formed entirely therethrough. The passageway 212c includes fastener receiving ends or regions 212e (configured to non-rotatably receive a fastener or fastener head therein) and includes a pair of spaced apart ring receiving grooves or channels 212f established at or near the generally central region 212a for receiving a respective locking ring or retainer 222, 223 therein.

The locking rings 222, 223 may comprise split rings similar to locking ring 122, discussed above, such that a detailed discussion of the locking rings need not be repeated herein. During the assembly of the ratchet and socket assembly 224, a locking ring 222 is inserted into passageway 212c when in a compressed state and is released to an expanded state at one of the grooves or channels 212f, whereby the locking ring 222 is retained partially in groove or channel 212f to provide a stop surface against which ratchet device 210 may engage when the ratchet device 210 is inserted into socket element 212. After the ratchet device 210 is inserted into the passageway 212c and rests against the locking ring 222, the second locking ring 223 may be inserted into passageway 212c when in a compressed state and released to an expanded state at the other of the grooves or channels 212f, whereby the locking ring 223 is retained partially in groove or channel 212f to retain the ratchet device 210 in the socket element 212 and between the locking rings 222, 223.

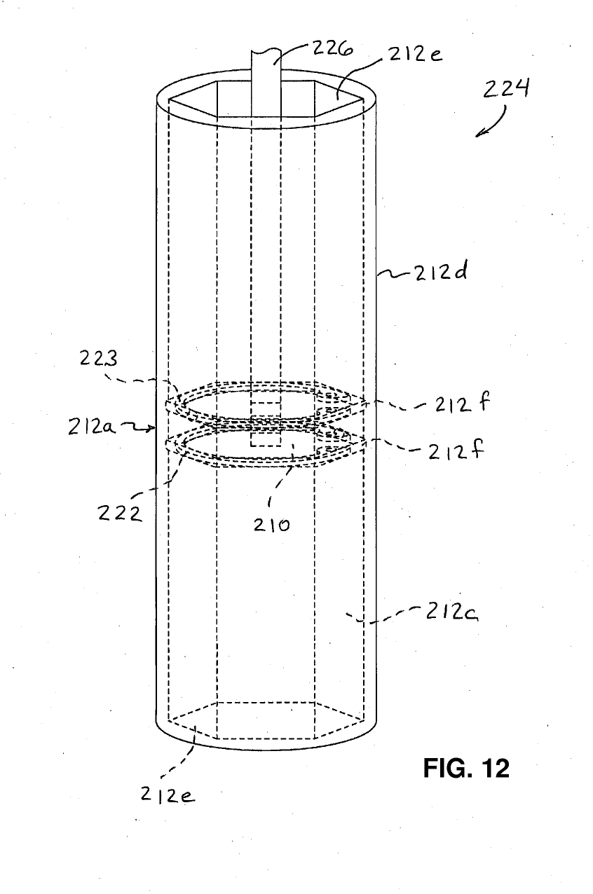

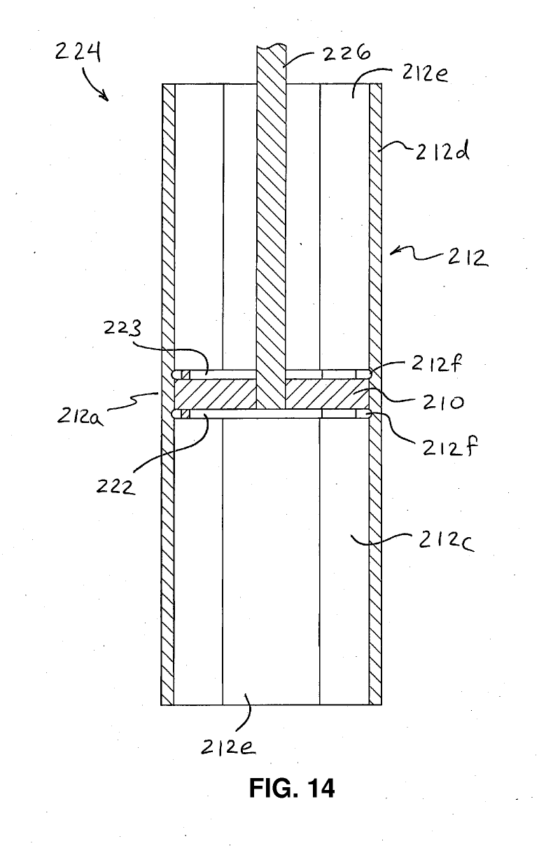

Thus, the self-contained ratchet device or module or unit 210 is generally fixedly retained in the socket element 212 via the pair of snap rings or locking rings 222, 223. Self-contained ratchet device or module 210 comprises a one-way or uni-directional ratcheting mechanism and, thus, in order to reverse the driving direction of the ratchet and socket assembly 224, the entire assembly can be flipped over or reversed so that the fastener that is to be driven is received in an opposite end of the socket element, As shown in FIGS. 12 and 14, the lever arm connecting portion 226 is an elongated connecting portion so that it is long enough to extend along the passageway 212c of socket element 212 to the generally central region 212a of socket element 212 and into the aperture 216a of the ratchet device 210, whereby rotation of the connecting portion 226 in one direction rotatably drives the ratchet device and socket element and rotation of the connecting portion in the opposite direction causes ratcheting of the ratchet device which allows for relative rotation between the connecting portion 226 and the socket element. The self-contained ratchet device or module or unit 210 may be substantially similar to ratchet device 110, discussed above, or may comprise any suitable ratcheting mechanism, such that a detailed discussion of the ratchet devices need not be repeated herein,

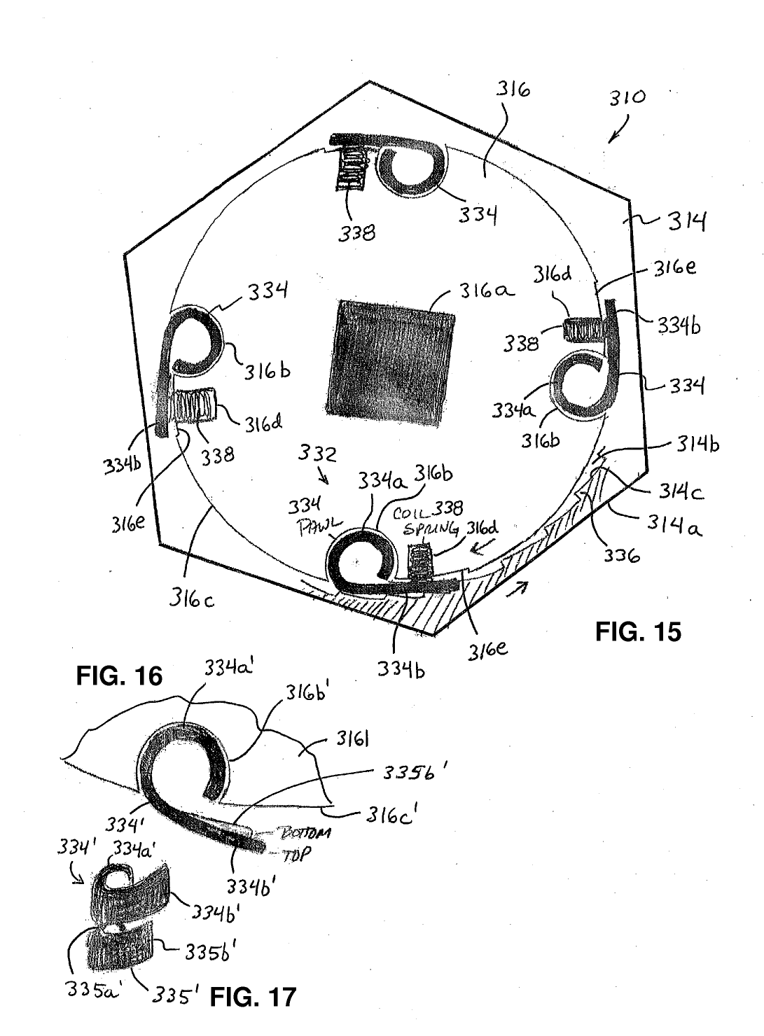

Thus, the ratchet device or module of the present invention may comprise any suitable ratcheting means or mechanisms, which may include one or more pawls that engage teeth to allow for relative rotation in one direction and non-relative rotation in the other direction, such as pawl and teeth configurations as known in the art of conventional ratchet wrenches. Optionally, for example, and with reference to FIG. 15, a ratchet device or module 310 may include an outer housing or shell or driven member 314 that has a non-circular perimeter shape to correspond to the non-circular shape of a passageway or receiver of a socket element or the like, and a driving member 316. The housing 314 of ratchet device 310 comprises, for example, a generally hexagonal-shaped outer surface 314a with a generally cylindrical through-hole or passage 314b that defines a generally cylindrical chamber in which the driving member 316 is housed. A cover or sealing element (not shown in FIG. 15) may be secured at each of the opposite ends of the housing 314 to substantially seal the driving member 316 and ratcheting mechanism 332 therein. The housing 314 thus may be received in or partially in a socket element to provide a ratchet function at the socket element, and the driving member 316 may include a drive tool receiving or attaching recess 316a for rotatably driving the driving member via a T-bar or lever arm or the like, such as in a similar manner as described above,

In the illustrated embodiments, the ratcheting mechanism 332 comprises a plurality of pawls 334 that are pivotally disposed at driving member 316 and that engage a plurality of teeth 336 disposed or established along an inner surface 314c of housing 314. The pawls 334 comprise metallic tabs (or other suitable material, such as a substantially rigid metallic or polymeric material or the like) with a partially coiled or partially circular base portion 334a and a tooth engaging tab portion 334b extending from the base portion 334a. Base portion 334a is received in a partially circular recess 316b established in the generally cylindrical side wall 316c of driving member 316, and base portion 334a is pivotable within recess 316b to allow the tab portion 334b to pivot towards and away from the sidewall 316c of driving member 316 during operation of the ratchet mechanism, as discussed below. As can be seen in FIGS. 15 and 16, the partially circular recess 316b may have a cross dimension or gap at the outer circumferential surface of the inner or driving member 316 that is less than the diameter of the base portion 334a of the pawl 334. Thus, the base portions of the pawls may be set into the recesses along the axis of the inner or driving member, whereby radial movement of the base portions is limited or substantially precluded by the partially closed recess at the outer surface of the driving member (with the gap being sufficient to have the tab portion of the pawl extend therethrough and pivot through its range of motion between its retracted state and its engaging state). Ratchet mechanism 332 also includes a biasing element or spring 338 disposed at respective recesses 316d at sidewall 316c for engaging the tab portion 334b of the respective pawl 334 and urging the tab portion away from sidewall 316c of driving member 316 for engagement with the teeth 336, as also discussed below.

As shown in FIG. 15, the tab 334b of pawl 336 is urged outward away from sidewall 316c of driving member 316 to engage an adjacent or nearby tooth 336 (preferably with a flat end of the tab 334b substantially interfacing or mating with a correspondingly flat face of the tooth 336, with the interface plane being generally normal to a plane tangent to the sidewall 316c at that location), whereby rotation of the driving member 316 in the clockwise direction in FIG. 15 will rotatably drive the housing 314 in the clockwise direction (and will rotatably drive the socket element in which the ratchet module 310 is received). The biasing element or spring 338 urges the tab 334b away from sidewall 316c to maintain engagement between the tab and the tooth during such driving of the ratchet module. When the driving member 316 is rotated in the opposite direction (such as in the counter-clockwise direction in FIG. 15), the tab is urged towards the sidewall 316c and against the spring 338 (via rotation of the base portion 334a of pawl 334 pivoting or rotating within recess 316b at driving member 316) as the tab slides along the ramped surface of the next adjacent tooth 336 to allow for relative rotation between the driving member and the housing (and thus between the driving member and the socket element). Optionally, and as shown in FIG. 15, the sidewall 316c may include recesses 316e established along where the tab portions 334b may extend to allow for further retraction of the tab portions 334b of the pawls 334 to provide sufficient clearance between the sidewall 316c and the teeth 336 for the tab portion 334b during such ratcheting of the driving member relative to the housing.

Optionally, the pawls and teeth may be configured so that each pawl engages a respective tooth at the same time, such that all of the pawls (shown as four pawls, but any number greater than or less than four pawls may be used depending on the particular application) function together to limit the relative rotation in the driving direction to enhance the strength and force capabilities of the ratchet mechanism, Optionally, the pawls and teeth may be configured such that they provide a staggered engagement, whereby one or more pawls may engage respective teeth at one orientation of the driving member relative to the housing, while one or more other pawls may engage other respective teeth at another orientation of the driving member relative to the housing. Such a configuration may provide a smaller degree of rotation between the pawl-teeth engagements or “clicks” of the ratchet mechanism and thus may provide a reduced degree of rotation of the handle to engage the teeth and thus may provide enhanced ratcheting capabilities,

Optionally, and with reference to FIGS. 16 and 17, the driving member 316′ may have a recess 316b′ established at its sidewall 316c′ that receives two pawls 334′, 335′ stacked one on top of the other. In the illustrated embodiment, pawl 334′ includes a base portion 334a′ that is pivotally received in recess 316b′ and a tab portion 334b′ that extends from base portion 334a′ such as in a similar manner described above with respect to pawl 334. Likewise, pawl 335′ includes a base portion 335a′ that is pivotally received in recess 316b′ and a tab portion 335b′ that extends from base portion 335a′ such as in a similar manner described above with respect to pawl 334. As shown in FIGS. 16 and 17, the lengths of tabs 334b′ and 335b′ are different (with tab 335b′ being shorter than tab 334b′) so that the pawls engage the adjacent teeth (not shown in FIGS. 16 and 17) at different orientations of the driving member relative to the housing. Although not shown in FIGS. 16 and 17, each pawl may be biased or urged away from the sidewall 316b′ of driving member 316′ via a respective spring (or via a single spring or biasing element that engages both tab portions 334b′, 335b′ or the like), such as in a similar manner as described above.

Thus, by providing different length tabs or tab portions 334b′, 335b′ (and optionally more than two different lengths, such as by stacking three or more pawls at the driving member), the ratchet mechanism provides different engagement points with the teeth to provide a finer tooth feel to the ratchet mechanism. The height of the pawls 334′, 335′ may be about one half the height of pawls 334, such that either embodiment may be implemented at a similar low profile driving member and ratchet device or module. Optionally, it is envisioned that the housing may have two levels of teeth, with one set of teeth facing one direction around the inner surface of the housing and with the other set of teeth facing the opposite direction around the inner surface of the housing, whereby a double stack pawl configuration may have a set of pawls facing one direction for engaging a respective set of teeth, while another set of pawls may be disposed above or below the first set and may face the other direction for engaging the other set of teeth. Thus, the pawl and teeth ratchet mechanism of the present invention may provide a two way ratchet mechanism (with a switch or user input to cause one set of pawls to retract towards the sidewall of the driving member to allow for relative rotation of the driving member and housing without having those pawls engaging their respective set of teeth).

The ratchet mechanism of the present invention is suitable for use in a ratchet module of the socket and ratchet assembly or combination of the present invention. However, it is envisioned that such a pawl and teeth configuration, with the pawls pivotally disposed at the inner driving member and the teeth disposed at an inner facing surface of an outer housing or driven member, may be suitable for any other types of ratchet tools, such as a socket driving ratchet handle or tool similar to conventional ratchet tools or the like. Optionally, a tool handle may receive or be attached to the outer portion (having the teeth disposed around an inner surface thereof), with the inner portion (having the pawls disposed at an outer surface thereof) being rotatably driven via rotation of the handle and outer portion in a driving direction, whereby the inner portion may have a square driver or the like for engaging or being received at or in a conventional socket element for rotatably driving the socket element. The pawls may freely or substantially freely pivot within the recesses established at the inner portion, and may be biased outwardly to assist in engaging the teeth of the outer portion when rotated in the driving direction. For example, if the outer portion is the driving portion (the portion rotatably driven by the handle or the like), the driving direction is in the clockwise direction in FIG. 15 and thus rotation of the outer portion in the clockwise direction rotatably drives the inner portion in that direction, while, if the inner portion is the driving portion (the portion rotatably driven by the handle or the like), the driving direction is in the counter-clockwise direction in FIG. 15 and thus rotation of the inner portion in the counter-clockwise direction rotatably drives the outer portion in that direction.

Thus, the socket and ratchet assembly or combination of the present invention provides a self-contained ratcheting device or unit or module that is incorporated in a socket element. The socket and ratchet assembly allows for manufacture of low cost socket elements, which include a selected diameter passageway entirely therethrough (which can be readily formed without the need to make or establish an attaching hole or portion at and end of the socket for attaching the socket to a lever arm or ratchet handle), The passageway of the socket element thus has a constant cross-sectional profile configured to generally correspond to an outer surface profile of the housing of the ratchet device and to an outer surface profile of a fastener element that is to be rotatably driven by the socket element. Such a constant cross-sectional profile or uniform passageway may be readily formed through a cylindrical metallic element to form or establish the socket element. Thus, the socket and ratchet assembly can provide a plurality of low cost socket elements, and a plurality of self-contained ratchet devices or modules or units that may be readily inserted into a socket element in a desired or selected orientation and retained therein to provide the desired drive direction for the socket and ratchet assembly.

The ratchet device or module may attach or engage the inner surface of the generally uniform passageway of the socket element when applied to the socket element, and may be at least partially inserted into or at least partially received in the socket passageway to engage the outer structure of the ratchet device with the inner wall of the socket element (or to engage the outer structure of the ratchet device with an adapter that engages the inner wall of the socket element). The ratchet device may be generally fixedly retained at or in the socket element or may be detachably retained at the socket element, and optionally, one ratchet device or module or unit may be adapted for use in multiple sized socket elements, such as via selected or appropriately sized sleeves or spacers. The socket and ratchet assembly, when assembled together, may be rotatably driven in the selected direction via a low cost lever arm or breaker bar or T-bar or the like (with no ratchet mechanism incorporated therein), and the direction of driving rotation may be selected (such as to tighten or loosen a fastener) and adjusted via turning or flipping the ratchet unit over in the socket element for applications where the ratchet unit is removably disposed at an end region of a socket element, or via turning or flipping the ratchet and socket assembly over for applications where the ratchet unit is fixedly retained in the socket element with the socket element having fastener receiving ends at opposite ends thereof.

Changes and modifications in the specifically described embodiments can be carried out without departing from the principles of the present invention, which is intended to be limited only by the scope of the appended claims as interpreted according to the principles of patent law.

1. A socket and ratchet combination comprising:
a ratchet device, wherein said ratchet device comprises a self-contained ratchet device module having a housing that houses a ratchet mechanism, and wherein said ratchet device is configured to connect to a drive member of a lever arm;
a socket element, wherein said socket element includes a passageway that is configured to receive said ratchet device therein, and wherein said passageway of said socket element is configured to at least partially receive said housing of said ratchet device therein; and
wherein, when said drive member of said lever arm is connected to said ratchet device and said lever arm is rotated in a first direction, said ratchet device and said socket element rotate in said first direction to rotatably drive a fastener at least partially received at an end region of said socket element, and wherein, when said drive member of said lever arm is connected to said ratchet device and said lever arm is rotated in a second direction, said ratchet device allows said lever arm to rotate in said second direction relative to said socket element.

2. The socket and ratchet combination as claimed in claim 1, wherein said ratchet device comprises a uni-directional ratchet mechanism.

3. The socket and ratchet combination as claimed in claim 1, wherein said passageway of said socket element extends entirely through said socket element.

4. The socket and ratchet combination as claimed in claim 3, wherein said passageway of said socket element has a constant cross-sectional profile configured to generally correspond to an outer surface profile of said housing of said ratchet device and to an outer surface profile of a fastener element that is to be rotatably driven by said socket element.

5. The socket and ratchet combination as claimed in claim 1, wherein said ratchet device is removably received in said socket element.

6. The socket and ratchet combination as claimed in claim 1, comprising a stop element disposed in said socket element to establish a stop surface at which said ratchet device engages when inserted into said passageway of said socket element.

7. The socket and ratchet combination as claimed in claim 6, wherein said ratchet device is retained in said socket element and at said stop element via at least one retaining element.

8. The socket and ratchet combination as claimed in claim 7, wherein said at least one retaining element comprises at least one magnetic element, and wherein said at least one magnetic element comprises at least one of (a) a body of said socket element, (b) said housing of said ratchet device and (c) said stop element.

9. The socket and ratchet combination as claimed in claim 7, wherein said at least one retaining element comprises a ball and detent configuration with one of said socket element and said ratchet device comprising a ball element and the other of said socket element and said ratchet device comprising a detent for partially receiving said ball element therein when said ratchet device is disposed in said socket element at said stop element.

10. The socket and ratchet combination as claimed in claim 1, wherein the driving direction of said socket and ratchet combination is reversible by removing said ratchet device from said socket element and turning said ratchet device over 180 degrees and reinserting said ratchet device into said socket element,

11. The socket and ratchet combination as claimed in claim 1, wherein said ratchet device is inserted into said passageway and retained therein via at least one retaining element.

12. The socket and ratchet combination as claimed in claim 11, wherein said at least one retaining element comprises at least one retaining ring at least partially received in a circumferential groove established at an inner surface of said passageway of said socket element.

13. The socket and ratchet combination as claimed in claim 12, wherein said ratchet device is disposed at a generally central region of said socket element and retained therein via a pair of spaced apart retaining rings disposed at opposite sides of said ratchet device to limit movement of said ratchet device in either direction along said passageway of said socket element.

14. The socket and ratchet combination as claimed in claim 13, wherein the driving direction of said socket and ratchet combination is reversible by turning over said socket and ratchet combination such that the fastener is received at an opposite end portion of said socket element.

15. The socket and ratchet combination as claimed in claim 1, further comprising at least one sleeve element to adapt said ratchet device for different sized socket elements, and wherein said sleeve element substantially encompasses a periphery of said housing of said ratchet device and engages an inner surface of said passageway of said socket element when said ratchet device and said sleeve element are received in said passageway,

16. The socket and ratchet combination as claimed in claim 1, wherein said ratchet device comprises a two-directional ratchet mechanism and wherein a user of said socket and ratchet combination selects a drive direction of said ratchet device,

17. The socket and ratchet combination as claimed in claim 1, wherein said self-contained ratchet device module comprises a driving member received in said housing, and wherein said housing comprises a plurality of teeth disposed along an inner surface of said housing, and wherein said driving member comprises at least one pawl disposed at an outer sidewall of said driving member that generally faces said inner surface of said housing, and wherein said at least one pawl engages said teeth of said housing to limit relative movement between said driving member and said housing when said driving member is rotated in said first direction via said drive member of said lever arm.

18. The socket and ratchet combination as claimed in claim 17, wherein said at least one pawl comprises a plurality of pawls spaced around the circumference of said driving member.

19. The socket and ratchet combination as claimed in claim 18, wherein each of said pawls comprises a base portion and a tab portion, and wherein said base portion of each pawl is pivotally received in a respective recess established in said driving member and wherein said tab portion extends from said base portion for engaging said teeth,

20. The socket and ratchet combination as claimed in claim 19, wherein said tab portions are urged away from said sidewall of said driving member by a respective biasing element disposed at said driving member.

21. A socket and ratchet combination comprising:
a socket element, said socket element having a passageway and an axis of rotation coaxial with said passageway;
a self-contained ratchet module, said ratchet module having a peripheral surface received in and engaging said passageway of said socket element and an input drive receiving formation disposed on said axis of rotation of said socket element and configured to connect with an input drive device to receive a rotational input drive therefrom; and
wherein, when said input drive is applied to said input drive receiving formation in a first direction of rotation, said input drive is transmitted to said socket element by said engagement between said peripheral surface and said passageway, and wherein, when said input drive is applied to said input drive receiving formation in a second direction of rotation, said ratchet module permits rotation of said drive receiving formation relative to said socket element.

22. The socket and ratchet combination as claimed in claim 21, wherein said ratchet module is releasably connected with said socket element by a quick-release retaining device.

23. The socket and ratchet combination as claimed in claim 22, wherein said quick-release retaining device comprises a push-fit retaining device.

24. The socket and ratchet combination as claimed in claim 21, wherein said passageway extends entirely through said socket element and has a constant cross-sectional profile configured to generally correspond to the peripheral surface of said ratchet module and the cross-sectional profile of a fastener element that is to be rotatably driven by said socket element.

25. The socket and ratchet combination as claimed in claim 21, comprising a plurality of said socket elements having respective passageways, wherein said passageways of said socket elements having respective different sizes and wherein said ratchet module is provided with a removable adapter to define at least one additional peripheral surface whereby said ratchet module has respective peripheral surfaces to engage said different sized passageways.

26. The socket and ratchet combination as claimed in claim 21, wherein said self-contained ratchet module comprises a driving member received in a housing, and wherein said driving member comprises said input drive receiving formation and said housing comprises said peripheral surface and a plurality of teeth disposed along an inner surface of said housing, and wherein said driving member comprises at least one pawl disposed at an outer sidewall of said driving member that generally faces said inner surface of said housing, and wherein said at least one pawl engages said teeth of said housing to limit relative movement between said driving member and said housing when said driving member is rotated in said first direction via said input drive being applied to said input drive receiving formation in said first direction of rotation.

27. The socket and ratchet combination as claimed in claim 26, wherein said at least one pawl comprises a plurality of pawls spaced around the circumference of said driving member.

28. The socket and ratchet combination as claimed in claim 27, wherein each of said pawls comprises a base portion and a tab portion, and wherein said base portion of each pawl is pivotally received in a respective recess established in said driving member and wherein said tab portion extends from said base portion for engaging said teeth.

29. The socket and ratchet combination as claimed in claim 28, wherein said tab portions are urged away from said sidewall of said driving member by a respective biasing element disposed at said driving member.

30. A socket and ratchet system comprising:
a plurality of socket elements, each of said socket elements having a different diameter passageway for receiving a different diameter fastener element therein;
a ratchet module having an outer structure configured to engage an inner wall of one of said socket elements, with the other of said sockets having a larger diameter than said outer structure;
wherein said ratchet module comprises a self-contained ratchet module having a housing that houses a ratchet mechanism and having a input drive connecting structure at an axis of rotation of said ratchet module, wherein said ratchet module is configured to connect to a drive member of a lever arm at said input drive connecting structure;
wherein, when said drive member of said lever arm is connected to said ratchet module and said lever arm is rotated in a first direction, said ratchet mechanism and a respective socket element rotate in said first direction to rotatably drive a fastener at least partially received at an end region of said respective socket element, and wherein, when said drive member of said lever arm is connected to said ratchet module and said lever arm is rotated in a second direction, said ratchet mechanism allows said lever arm to rotate in said second direction relative to said respective socket element; and
wherein said system further comprises a plurality of adapters that are each selectively disposed at least partially around said outer structure of said ratchet module to adapt the diameter of said outer structure of said ratchet module for use in a different diameter socket element.

31. The socket and ratchet system as claimed in claim 30, wherein said passageway extends entirely through said respective socket element and has a constant cross-sectional profile configured to generally correspond to the cross-sectional profile of a fastener element that is to be rotatably driven by said socket element and one of the cross-sectional profile of said outer structure of said ratchet module or the cross-sectional profile of a respective one of said adapters disposed at least partially around said outer structure of said ratchet module.

32. The socket and ratchet system as claimed in claim 30, wherein said ratchet module comprises a uni-directional ratchet mechanism,

33. The socket and ratchet system as claimed in claim 30, wherein said ratchet module is selectively removably disposed in one of (a) said one of said socket elements and (b) one of said plurality of adapters.

34. The socket and ratchet system as claimed in claim 30, comprising a stop element disposed in each of said socket elements to establish a stop surface at which at least one of said ratchet module and said adapter engages when inserted into said passageway of said socket element.

35. The socket and ratchet system as claimed in claim 34, wherein said at least one of said ratchet module and said adapter is retained in said socket element and at said stop element via at least one retaining element.

36. The socket and ratchet system as claimed in claim 35, wherein said at least one retaining element comprises at least one magnetic element, and wherein said at least one magnetic element comprises at least one of (a) a body of said socket element, (b) said housing of said ratchet module, (c) said adapter and (d) said stop element,

37. The socket and ratchet system as claimed in claim 30, wherein the driving direction of said socket and ratchet system is reversible by removing said ratchet module from said socket element and turning said ratchet module over 180 degrees and reinserting said ratchet module into said socket element.

38. The socket and ratchet system as claimed in claim 30, wherein said ratchet module is inserted into said passageway and retained therein via at least one retaining element,

39. The socket and ratchet system as claimed in claim 38, wherein said at least one retaining element comprises at least one retaining ring at least partially received in a circumferential groove established at an inner surface of said passageway of said socket element.

40. The socket and ratchet system as claimed in claim 30, wherein said ratchet module comprises a two-directional ratchet mechanism and wherein a user of said socket and ratchet system selects a drive direction of said ratchet module,

41. A ratchet mechanism comprising:
an outer member having a generally cylindrical inner surface and a plurality of teeth disposed circumferentially around said inner surface;
an inner member disposed at least partially within said outer member, said inner member comprising at least one pawl disposed at an outer circumferential surface thereof; wherein said pawl is configured to engage said teeth of said outer member to limit rotation of said inner member relative to said outer member when one of said inner member and said outer member is rotatably driven in a driving direction;
wherein said pawl comprises a base portion and a tab portion, and wherein said base portion of each pawl is pivotally received in a respective partially circular recess established in said inner member and wherein said tab portion extends from said base portion for engaging said teeth of said outer member; and
wherein said tab portion is disposed generally along said outer circumferential surface of said inner member when in a retracted state and wherein said tab portion extends generally away from said outer circumferential surface when in an engaging state for engaging said teeth of said outer member.

42. The ratchet mechanism as claimed in claim 41, wherein said at least one pawl comprises a plurality of pawls spaced around the circumference of said inner member.

43. The ratchet mechanism as claimed in claim 42, wherein said tab portions are urged away from said sidewall of said inner member by a respective biasing element disposed at said inner member.

44. The ratchet mechanism as claimed in claim 43, wherein said inner member comprises a driving member that is rotatably driven via a driving handle and wherein said outer member is rotatably driven in said driving direction via engagement of said tab portions of said pawls with said teeth of said outer member when said inner member is rotated in said driving direction.

45. The ratchet mechanism as claimed in claim 44, wherein said ratchet mechanism comprises a ratchet unit disposed at a socket element.

46. The ratchet mechanism as claimed in claim 43, wherein said outer member comprises a driving member that is rotatably driven via a driving handle and wherein said inner member is rotatably driven in said driving direction via engagement of said tab portions of said pawls with said teeth of said outer member when said outer member is rotated in said driving direction.

47. The ratchet mechanism as claimed in claim 46, wherein said inner member comprises a drive element extending therefrom, and wherein said drive element is configured to be received in a socket to rotatably drive the socket responsive to rotation of said driving handle and said outer member in said driving direction.

48. The ratchet mechanism as claimed in claim 43, wherein each of said partially circular recesses has an opening at said outer circumferential surface of said inner member that has a cross dimension that is less than a diameter of said base portion of each of said pawls to limit radial movement of said base portions of said pawls relative to said inner member.

49. The ratchet mechanism as claimed in claim 43, wherein each of said plurality of pawls disposed at a respective one of said partially circular recesses comprises a pair of pawls axially aligned in said respective partially circular recess, and wherein one of said axially aligned pawls has a tab portion that is shorter in length than the tab portion of the other of said axially aligned pawls, whereby said tab portions of said axially aligned pawls engage different teeth of said outer member when in their engaging states,
